(19) United States
(12) Patent Application Publication
(10) Pub. No.: US 2004/0198073 A1
(43) Pub. Date: Oct. 7, 2004

(54) Electrical connector assembly structure

(76) Inventor: Jason S. Sloey, San Diego, CA (US)

Correspondence Address: North Star Systems Corp., P. O. Box No. 6-57, Chung-Ho, Taipei, 235, TW

(21) Appl. No.: 10/406,191

(22) Filed: Apr. 4, 2003

(51) Int. Cl. H01R 11/30

(52) U.S. Cl. 439/39

(57) ABSTRACT

A modified structure for an electrical connector assembly provides connection between electronics, such as mobiles, notebooks, digital cameras, personal digital assistants (PDAs), wherein the electrical connector assembly includes a female connector assembly for insertion and connection, and a mating connector. By interlocking said female connector and mating connector and further in connection with the independent power supply, data and power supply are integrated in the structure design of the electrical connector. This prevents data loss, computer breakdown or interruption of power supply while transmitting data caused by loosening of connection between the mating connector and the female connector assembly.

### BACKGROUND OF THE INVENTION

1) Field of the Invention

The present invention relates to a modified structure for an electrical connector assembly, more particularly in connection between electronic products such as mobile phones, notebooks, digital cameras, personal digital assistants (PDAs) in order to integrate data transmission and power supply.

2) Description of the Prior Art

Electrical connectors are widely used in connection with electrical signals, such as the connection between signal source and various electronics or electrical equipments. Through them, signal source is able to provide signals or power to electronics or electrical equipments. Therefore, it is necessary to enhance the connection structure between female connector assembly and mating connector of electrical connectors in order to keep the line open.

The technique in manufacturing the conventional electrical connector depends on the material and structure of connection terminals, and the delicate fitness between the female connector assembly and mating connector. However, it is known to the connector manufacturers that the material of connectors is extruded plastic, whereas volume change with temperature of the material and the controllable scope of the error in extrusion are concerned, the flaw rate in production and the exceeding cost is undoubtly high.

Moreover, when connection terminals are used as the connecting components for connectors, the force they bear is very likely to cause distortion in them. This would affect the connection effect of the connectors, not to mention the stability required in data transmission.

### SUMMARY OF THE INVENTION

The main purpose of the present invention, a modified structure for electrical connector assembly, comprising a female connector assembly of an electrical connector is to provide connection for a mating connector and integrate power supply in the same electrical connector. Moreover, the power supply is independent. Since a round port and terminals are independently disposed for the connection of power supply to thereby differentiate demands. If the female connector assembly requires only power storage, it can be accomplished by connecting to charger or adaptor independently.

Another purpose of the present invention is to provide a mating connector with a pressing area and groove-mount shields, which are mounted on the inner wall of the slot of the female connector assembly thereby allowing contact engagement. Without applying to the resistance of connection terminals, as used in convention electrical connectors, the present invention ensures the connection between the female connector assembly and mating connector of the electrical connector, thereby expending the lifetime of connection terminals and completing data transmission accurately.

To enable a further understanding of the structure and functions of the invention herein, the brief description of the drawings below are followed by detailed description of the most preferred embodiment of the present invention.

### BRIEF DESCRIPTION OF THE DRAWINGS

FIG. 1 is a perspective exploded drawing of the present invention, showing a modified structure for an electrical connector assembly.

FIG. 2 is a perspective exploded drawing of a female connector assembly of the present invention.

FIG. 3 is another perspective exploded drawing of a female connector assembly of the present invention.

FIG. 4 is a perspective exploded drawing of a mating connector of the present invention.

FIG. 5 is a top view of the connection between the female connector assembly and mating connector of the present invention.

FIG. 6 is a sectional side view of the connection between the female connector assembly and mating connector of the present invention.

FIG. 7 is a perspective exploded drawing of the present invention showing another preferred embodiment being assembled.

### DETAILED DESCRIPTION OF THE PREFERRED EMBODIMENTS

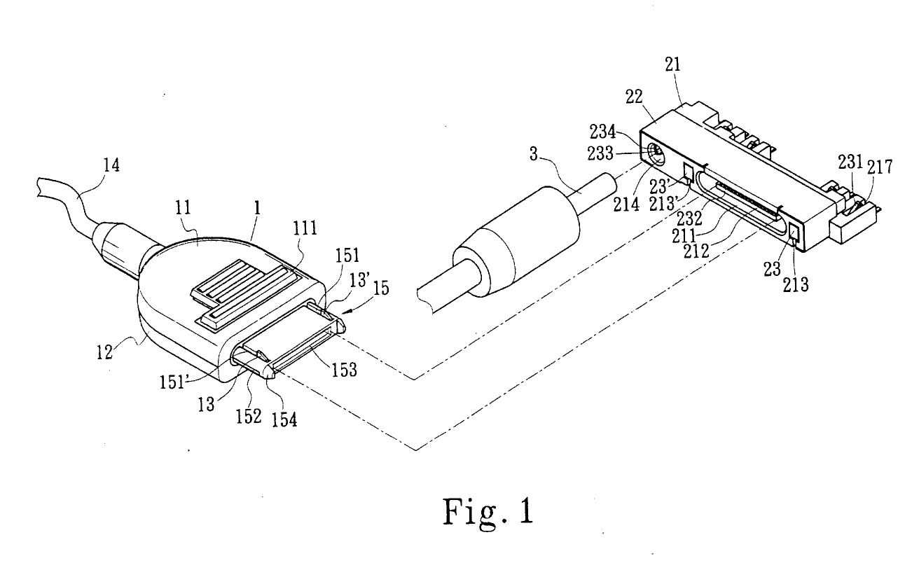

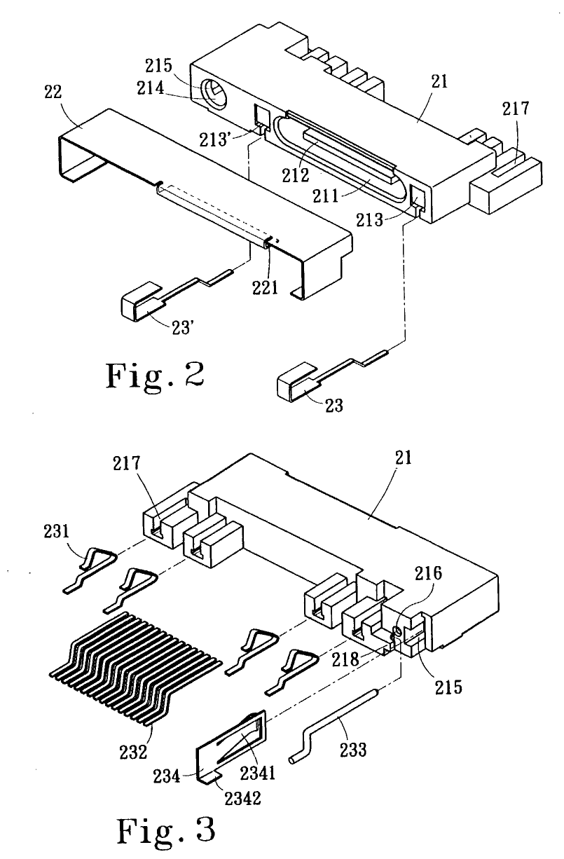

Referring to FIGS. 1, 2 and 3, the present invention comprises a mating connector (1) and a female connector assembly (2). The female connector assembly (2) herein is composed of a container base (21), a metal shield body (22), two correspondent U-shape pins (23, 23′), a plurality of connection terminals (231, 232), a power supply (233) and a stopping terminal (234). A slot (211) opened on one side of the container base (21) which is correspondent with a mating base (15) of the mating connector (1), as shown in FIG. 2. Moreover, a block (212) bulging from the center of the slot (211) comprises a plurality of connection terminals (232). Said block (212) is correspondent to a notch (153) on the mating base (15). When connecting, said block (212) mates with said notch (153) and connects with connection terminals (16) of the mating connector (1). An open slot (213, 213′) is disposed on each side of the slot (211) for receiving the U-shape pin (23, 23′). Said U-shape pins (23, 23′), as the positive and negative poles of power supply, thereby providing power storage. The female connector assembly (2) integrates power transmission in an electrical connector by the U-shape pins (23, 23′) in order to provide the power required by the server of the female connector assembly (2).

Furthermore, a round port (214) is disposed on one side of the container base (21), which defines a hole (216) and a groove (215). The hole (216) mates with a power supply (233) which is retained by a stopping block (218). A stopping terminal (234) is inserted in the groove (215) and positioned by a blocking piece (2342) thereof. Said stopping terminal (234) also defines a shielding area (2341). The round port (214) receives a plug (3) of power adaptor. One pole of said plug (3) contacts the power supply (233); the other contacts the shielding area (2341) of the stopping terminal (234). Therefore, it provides an alternative power supply, and thus power transmission is integrated in the female connector assembly (2) of the electrical connector. Moreover, the rear side of the container base (21) defines a plurality of identical slot ways (217), and a connection terminal (231) is disposed in each slot way (217) providing connection and retention.

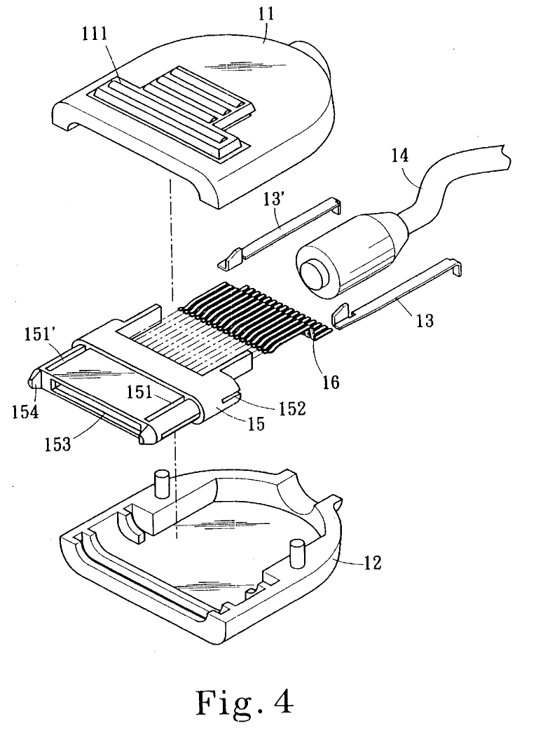

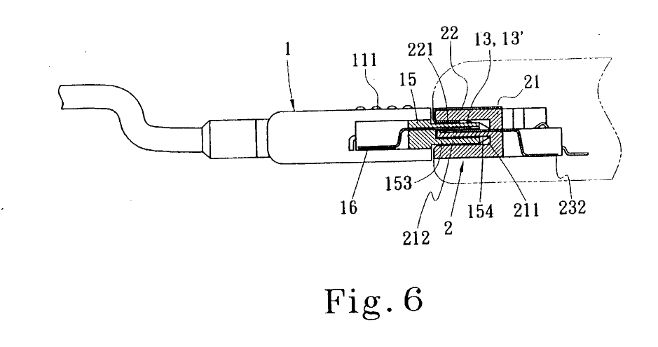

As for the structure of the mating connector (1), referring to FIG. 4, having a pair of correspondent covers (11, 12), comprises a mating base (15), a plurality of connection terminals (16), a pair of correspondent groove-mount members (13, 13′) and a transmission cable (14) therein. A pressing area (111) is disposed in the middle of the upper cover (11) thereof, which interlockingly controls the groove-mount members (13, 13′) inside. Said groove-mount member (13) mounts in a groove (151) via a lateral groove (152), same as the groove-mount member (13′) in the groove (151′) such that the mating connector (1) and the female connector assembly (2) are able to engage with each other while connecting. This prevents the data loss or transmission breakdown during data transmission due to loosening of the connection. Moreover, the rear side of the mating base (15) disposes a plurality of connection terminals (16) which are exposed in the notch (153). When the mating connector (1) connects with the female connector assembly (2), the notch (153) engages with the block (212) in the slot (211). A cone-shape stopping area (154) in the front of the mating base (15) helps with the positioning of the mating connector (1), whereby the connection terminals (16) connect to the connection terminals (232), as shown in FIG. 6. However, the input and output of data in each connection terminal (16) is completed via the transmission cable (14).

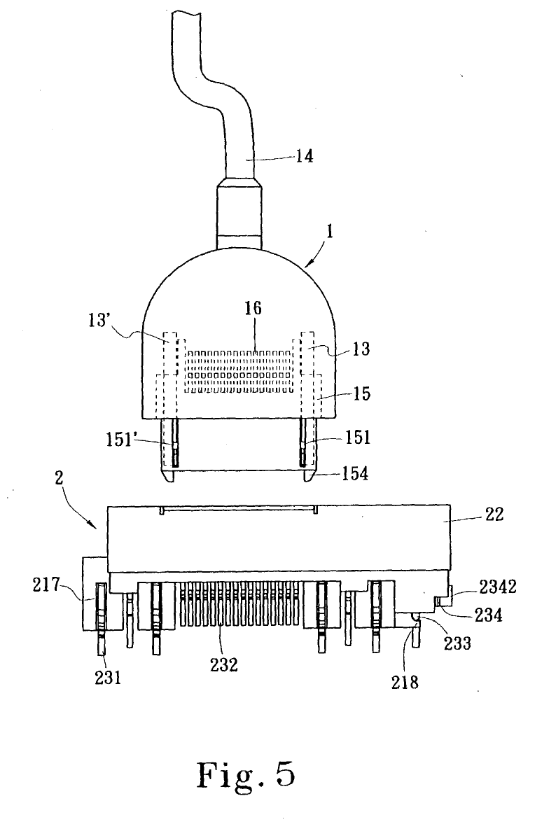

As mentioned above, referring to FIGS. 5 and 6, when mating the mating connector (1) and the female connector assembly (2), the notch (153) of the mating base (15) is pushed into the slot (211) and interlocked with the block (212) thereof. Moreover, when the cone-shape stopping area (154) in the front of the mating base (15) is pushed forward, the groove-mount members (13, 13′) correspondingly contact and mount on the stopping wall (221) of the metal shield (22) thereby forming a stopping mechanism. The connection terminals (16) then make connection with the connection terminals (232) proceeding data transmission. Upon releasing, one only needs to press the pressing area (111) on the upper cover (11) thereby releasing the groove-mount members (13, 13′) from the stopping wall (221), and then separates the female connector assembly (2) from the mating connector (1). Unlike the conventional electrical connector, the connection structure of the present invention does not depend on the connection terminals. Therefore the lifetime of the connection terminals (16, 232) are extended, and data transmission is completed accurately.

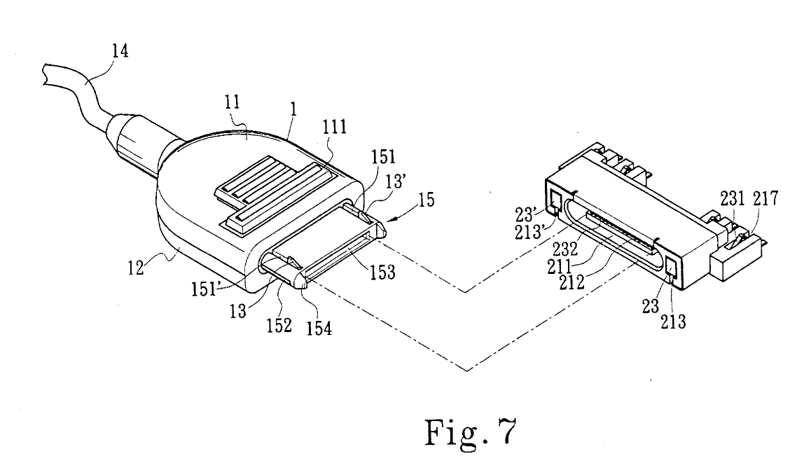

Moreover, referring to FIG. 7, a perspective drawing of the present invention showing another preferred embodiment being assembled, a female connector assembly (2′) herein has similar structure to the female connector assembly (2) mentioned above (please also refer to FIG. 1). Compared to the female connector assembly (2), the round port (214) structure including components such as power supply (233) and stopping terminal (234) is absent in the preferred embodiment of the female connector assembly (2′) herein. The power storage of this preferred embodiment can only be transmitted through the U-shape pins (23, 23′) on both sides of the slot (211). It does not provide connection for a round plug (3) of the conventional power adaptor, although the way of mating between the mating connector (1) and the female connector assembly (2′) remains the same. The purpose hereof is to provide an alternative design for the preferred embodiment.

To sum up, the present invention has been described with preferred embodiments thereof and it is understood that many changes and modifications in the described embodiments can be carried out without departing from the scope and the spirit of the invention that is intended to be limited only by the appended claims.

1. An electrical connector assembly having an electrical connector structure for the integration of data transmission and power supply, comprising:
a female connector assembly including an electronic connection port;
a slot disposed in the front of said female connector assembly for housing a mating connector;
a metal shield disposed in the front rim of said female connector assembly;
at least one connection terminal disposed in the slot of said female connector assembly and connected with the mating connector thereby proceeding data transmission;
a pair of correspondent u-shape pins disposed in the front rim of said female assembly connecting power supply;
a round port disposed in the front rim of said female assembly connecting an alternative power supply.

2. An electrical connector assembly according to claim 1, wherein said slot comprising a bulging block herein and having a plurality of connection terminals for data transmission.

3. An electrical connector assembly according to claim 1, wherein said U-shape pins disposed respectively on two sides of the slot performing as positive and negative poles thereby connecting power supply.

4. An electrical connector assembly according to claim 1, wherein said round port having at least two terminals used for positive and negative poles during power transmission.

5. An electrical connector assembly having a mating connector connected with a female connector assembly comprising:
at least a base including an electronic plug for connection with a female connector assembly;
at least one connection terminal disposed in a notch of said base providing data transmission while connected to the female connector assembly;
a pair of groove-mount members engaging a mating base with the female connector assembly;
a transmission cable transmitting data from the connection terminal;
a pair of corresponding covers housing components of the mating connector therein;

6. An electrical connector assembly according to claim 5, wherein an upper cover of said mating connector having a pressing area which interlockingly controlling said pair of groove-mount members and further in connection with the female connector assembly.

7. An electrical connector assembly according to claim 5, wherein said groove-mount member being to a resilient component with flexibility.

8. An electrical connector assembly according to claim 6, wherein said groove-mount member being to a resilient component with flexibility.
